(19) United States
(12) Patent Application Publication
(10) Pub. No.: US 2006/0093762 A1
(43) Pub. Date: May 4, 2006

(54) Masterbatch

(76) Inventors: Dirk Niekamp, Bad Essen (DE); Jorg Niesmann, Osnabruck (DE); Andreas Overberg, Osnabruck (DE)

Correspondence Address: AMSTER, ROTHSTEIN & EBENSTEIN LLP, 90 PARK AVENUE, NEW YORK, NY, 10016, US

(21) Appl. No.: 11/085,402

(22) Filed: Mar. 21, 2005

(30) Foreign Application Priority Data
Nov. 2, 2004 (DE) 20 2004 005 474.4

(51) Int. Cl. B41M 5/00

(52) U.S. Cl. 428/32.34

(57) ABSTRACT

A masterbatch (polymer/pigment concentrate) for the production of support materials for imaging processes comprises 25 to 80% by weight of a titanium dioxide, 20 to 75% by weight of a polyolefin resin, 0.1 to 10% by weight of alkali aluminosulphosilicate red pigment, 0.1 to 6% by weight of a stabilizer based on the mass of the masterbatch in each case and provides excellent polyolefin/pigment coatings in the production of support materials for imaging processes.

### BACKGROUND OF THE INVENTION

The invention relates to a polymer concentrate (master batch) for the production of a coating material for support materials for imaging layers and support materials produced by using the masterbatch, such as photographic base papers, support materials for ink jet printing and D2T2 printing.

Waterproof photographic support materials include a sized raw paper with waterproof polyolefin resin layers on both sides of the raw paper. The polyolefin layer is applied onto the raw paper by extrusion.

The resin layer on the front side of a photographic support material usually contains light-reflecting white pigments, dyes, color pigments, optical brighteners, stabilizers, dispersants, release agents, slips, antioxidants and antistatics. Titanium dioxide is the most important white pigment in the layer on the face of a photographic base paper.

A precondition for the full development of the pigment properties in the resin and for problem-free processing is the complete fragmentation of the pigment agglomerates and the homogeneous distribution of the pigment particles, in particular the titanium dioxide particles. This is of particular importance in the production of thin layers or films since pigment agglomerates lead to the formation of holes and consequently to the tearing of a film. A good dispersion of the titanium dioxide in the polyolefin resin is consequently required.

For these reasons, it has been known for a long time to use pigment/polymer concentrates, the so-called masterbatches, in which the pigment is already present in the dispersed form, rather than the pure pigments, for pigmenting polyolefins. The manufacture of such concentrates takes place in a special operating process via the soft phase. Kneaders, rolling mills and extruders are suitable for this purpose, the increase in the shear forces effecting an improvement in the state of dispersion. The production of such masterbatches is described in U.S. Pat. No. 5,049,595, for example.

A frequent component of masterbatches is the so-called PV Echtrosa. This is an organic pigment which occurs in the polyolefin layering compound in a concentration of 0.02 to 0.01% by weight and more, based on the mass of the layering. The use of this organic pigment is described in EP 0 571 721 A1. This organic pigment has proved its worth and has been used for many years on large scale as red pigment in masterbatches for the production of photographic support materials.

### SUMMARY OF THE INVENTION

When applying polyolefin layers onto raw paper by extrusion, a number of undesirable effects may occur which lead to a lack of quality of the photographic support material (photographic base paper). These undesirable effects include the so-called die lines, for example. These are formed by decomposition products of the material to be extruded onto the raw paper, which decomposition products deposit on the die edges of the extruder die. If the so-called die lines occur on the layered paper as a result of these deposits, the extrusion process needs to be interrupted and the die cleaned. Consequently, it is desirable to avoid die lines so as to have to interrupt extrusion less frequently.

Surprisingly, it has been found that by replacing the organic red pigment PV Echtrosa by an inorganic red pigment based on an alkali aluminosulphosilicate in the masterbatch, almost no die lines occur during extrusion any longer.

The subject matter of the invention is consequently a masterbatch containing an alkali aluminosulphosilicate red pigment for the production of photographic support materials.

The masterbatch according to the invention contains
25 to 80% by weight of titanium dioxide
20 to 75% by weight of polyolefin resin
0.1 to 10% by weight of alkali aluminosulphosilicate red pigment
0.1 to 6% by weight of stabilizer
   based on the mass of the masterbatch in each case and, if necessary, other additives commonly used in masterbatches such as optical brighteners, antioxidants and color pigments.

### DETAILED DESCRIPTION OF THE PREFERRED EMBODIMENTS

According to a particularly preferred embodiment, the red pigment ultramarine violet is used. A particularly preferred red pigment is alkali aluminosulphosilicate with the designation CAS 12769-96-9. Its chemical composition is or is close to 2Na₂Al₂Si₂O₆xNa₂S. The red pigment can be used in a quantity of 0.1 to 10% by weight, preferably 1.0 to 2.0% by weight and, in a particularly preferred embodiment, in a quantity of 1.3 to 1.6% by weight, based on the mass of the masterbatch.

It has proved advantageous to use a blue pigment in addition to the above-mentioned red pigment. An inorganic ultramarine blue (CAS 57455-37-5) is particularly preferred. Its chemical composition is or is close to Na₂OSAl₂O₃SiO₂. The blue pigment can be contained in the masterbatch in a quantity of 0.05 to 5% by weight, preferably 0.2 to 0.6% by weight, based on the mass of the masterbatch.

Surprisingly, it has been found that the effect of the red pigment used according to the invention on the suppression of the die lines is further enhanced by the use of two stabilizers known as such. This effect is achieved in particular if the mass ratio of inorganic red pigment to the total mass of the stabilizers is 200:1 to 1:60, particularly preferably 40:1 to 1:1.

These stabilizers include preferably a phosphite antioxidant and a phenolic antioxidant. The phosphite antioxidant with the chemical name 2,4,6-tri-ter.-butylphenyl-2-butyl-2-ethyl-1,3-propane diol phosphite which is commercially available, is particularly preferred. According to the invention, the phosphite antioxidant can be used in a quantity of 0.05 to 3% by weight, particularly preferably in a quantity of 0.1 to 0.4% by weight, based on the mass of the masterbatch.

The phenolic antioxidant is preferably a (3,5-di-tert.-butyl hydroxyphenyl) propionic acid ester of pentaerythritol or octadecanol. The phenolic antioxidant with the chemical name octadecyl-3,5-di-tert.-butyl-4-hydroxyhydrocinnamate is particularly preferred. According to the invention, the phenolic antioxidant can be used in a quantity of 0.05 to 3% by weight, particularly preferably in a quantity of 0.1 to 0.6% by weight, based on the mass of the masterbatch.

Surprisingly, it has been found that the sole use of the phosphite antioxidant leads to an improvement in the flow properties of the polyolefin resin and consequently to a reduction in the so-called pits on the polyolefin resin surface. Pits are crater-shaped cavities which have a negative effect on the surface properties of the support material, such as gloss and smoothness, which are decisive for the quality of the image. Moreover, the use of the phenolic antioxidant contributes to an improvement in the so-called release properties, which means that an adhesion of the polymer film to the cooling cylinder after extrusion is suppressed.

By using the masterbatch according to the invention after dilution with a resin, it is possible to apply rates of extrusion of up to 600 m/min during extrusion layering without negative effects regarding the level of pits or problems regarding adhesion of the material to the cylinder occurring.

According to preferred embodiments of the masterbatch according to the invention, the total quantity of stabilizer can preferably be 0.1 to 4% by weight, 0.1 to 3% by weight and 0.1 to 1% by weight. A suitable quantitative ratio of phosphite antioxidant to phenol antioxidant can be 5:1 to 1:5, preferably 1:3 to 3:1, particularly 1:2 to 2:1.

Titanium dioxide can be used in the form of rutile or anatase. Rutile is preferred. The titanium dioxide may have been treated inorganically and/or organically. An organically treated titanium dioxide which is characterized by a carbon content of about 0.18 to 0.24% by weight is particularly preferred. The average particle size is preferably 0.20 to 0.35 μm. The oil number can preferably be less than 14, particularly preferably 10 to 12, e.g. approximately 11.

Brighteners suitable according to the invention comprise the amino stilbene sulphonic acid derivatives, diaryl pyrazolyl derivatives and bis(benzoxazolyl) stilbene derivatives. The brightener or a brightener mixture can be present in a quantity of 0.05 to 1% by weight, preferably 0.1 to 0.4% by weight, based on the mass of the masterbatch.

To produce the polyolefin layering of photographic base papers, different polyethylenes and their mixtures can be used. According to the invention, a so-called HDPE polyethylene or a LDPE ethylene or a mixture of both types, for example, can be used. However, ethylene/α-olefin copolymers (LLDPE) or polypropylene are also suitable.

The manufacture of the masterbatch according to the invention can take place by the method described in U.S. Pat. No. 5,049,595 using a double-screw extruder with a degasification zone. For this purpose, the components to be mixed are placed into the feeder of an extruder, for example, a double-screw extruder with two screws operating in a synchronal and unidirectional manner. The temperature at the inlet of the extruder can be 100 to 150° C., the temperature in the mixing zone approximately 120 to 200° C. and at the outlet of the extruder approximately 150 to 260° C. The residence time can be 5 to 10 minutes and the pressure 50 to 20,000 Pa. The masterbatch thus obtained can be granulated in the known way. Other mixing devices, such as a Banbury mixer, are also suitable to produce the masterbatch according to the invention.

The subject matter of the invention, moreover, consists of a support material which has been produced by using the masterbatch according to the invention. The support material according to the invention can be a support for photographic layers (photographic base paper) or a support material for other imaging processes. Such imaging processes comprise ink jet printing, dye diffusion thermal transfer-D2T2. Photographic support materials or photographic base papers should be understood to mean the support material of the photographic emulsion in which an image is created in the case of silver salt photography by exposing to light.

Before a support material is layered, the masterbatch according to the invention is diluted with a polyolefin resin such as a polyethylene which can be both an HDPE and an LDPE or a mixture of both types. Ethylene-α olefin copolymer (LLDPE) or polypropylene can also be used to dilute the masterbatch.

The dilution of the masterbatch takes place in such a way that the polyolefin layer on the raw paper contains up to 40% by weight of the titanium dioxide masterbatch and 60 to 99% by weight of the polyolefin resin used for dilution. A polyolefin layering with 5 to 25% by weight of the titanium dioxide masterbatch and 75 to 95% by weight of the polyolefin resin used to dilute the masterbatch is particularly preferred. Layering of the raw paper with the diluted titanium dioxide masterbatch takes place by extrusion using a flat sheet die (or slot die) in a temperature range of the extruder of 190 to 360° C. The polyolefin layering can be applied onto one or both side of the raw paper.

Support material materials suitable for layering consist of coated or non-coated raw papers and polymer films.

All types of cellulose fiber and synthetic fiber are suitable for the production of the raw paper. All sizing and wet strength agents known in the paper industry are suitable for sizing. Sizes with alkyl ketene dimers are particularly preferred. The raw paper can contain pigments and fillers such as kaolin, calcium carbonate, silica or titanium dioxide as well as other auxiliaries such as defoaming agents, optical brighteners and dyes. The raw paper can be produced on a Fourdrinier or cylinder paper machine. The basis weight of the raw paper can amount to 50 to 300 g/m², preferably 70 to 200 g/m². In addition, the raw paper can exhibit a surface size.

In the case in which the polyolefin layering is to be applied directly by extrusion onto one or both sides of the raw paper, it may be advantageous to subject the raw paper to a so-called corona discharge in order to improve the adhesion of the resin layer on the raw paper.

According to a further embodiment of the photographic support material according to the invention, a pigment layer can be applied onto the face of the raw paper and the synthetic resin can subsequently be applied onto this pigment layer on the raw paper by extrusion. By means of the pigment layer, a highly smooth surface is achieved which is capable of providing a highly smooth resin surface essentially free from pits in spite of a low application weight of the synthetic resin subsequently applied. The pigment layer applied for this purpose can contain calcium carbonate and a binder. According to a further preferred embodiment, the pigment layer may contain at least 30% by weight of kaolin. The calcium carbonate can be used in a selected narrow grain size distribution, at least 70% by weight of these particles having a size of less than 1 μm and at least 40% by weight of these particles having a grain size of 0.35 to 0.8 μm.

The application weight of the polyolefin layer usually amounts to 5 to 50 g/m², in particular 10 to 40 g/m². When using the pigment layer described above on the raw paper, the application weight of the polyolefin layer can be reduced by 12 to 25 g/m².

The following example has the purpose of further illustrating the invention.

### EXAMPLE

Production of the Masterbatch

LDPE polyethylene granules with a density of 0.923 g/m³ were continuously mixed with titanium dioxide (Rutile R 101, DuPont) and the other components of the masterbatch according to the invention according to the following recipe:

| | | |
|---|---|---|
| Titanium dioxide | 50.0% | by weight |
| Ultramarine blue | 0.3% | by weight |
| Ultramarine violet | 1.1% | by weight |
| Phosphite antioxidant | 0.5% | by weight |
| Phenol antioxidant | 1.0% | by weight |
| Optical brightener | 0.1% | by weight |
| LDPE | 47.0% | by weight |

Ultranox® 641 was used as phosphite antioxidant, Irganox® 1076 as phenolic antioxidant, Uvitex® as optical brightener. The ultramarine violet had the CAS no. 12769-96-9; the ultramarine blue had the CAS no. 57455-37-5. The titanium dioxide was a rutile titanium dioxide.

A double-screw extruder of the ZSK 30 type with screws operating in a synchronized and unidirectional manner was used for mixing. The temperature at the inlet of the extruder was about 120° C., the temperature in the mixing zone about 40° C. and at the outlet about 180° C. The residence time of the material to be homogenized in the extruder was 5 minutes at a pressure of 0.050 to 20 kPa. Subsequently, the material was granulated.

In addition, a masterbatch without phosphite antioxidant was produced.

Raw Paper

A standard photographic raw paper with a basis weight of 162 g/m² was used which was produced from a pulp suspension containing 100% by weight of hard wood sulphate pulp and 0.5% by weight of alkyl ketene dimer as well as 0.7% by weight of polyamide polyamine epichlorohydrin resin and had been surface-sized with oxidized starch.

The raw paper was used in the compacted, i.e. smoothed, form and had a density of 1.05 g/cm³.

Coating of the Raw Paper

A mixture of 18% by weight of the masterbatch described above and 72% by weight of an LDPE with a density of 0.923 was produced. The layering of the raw paper by extrusion was carried out at an extrusion rate of 350 m/min.

Determination of the Number of Pits

The surface of the paper layered with polyolefin is enlarged by using a microscope and scanned with a CCD camera. By means of an image processing software, a profile of the pits level at 45 different measuring points is drawn up.

A substantial improvement in the level of pits in the masterbatches produced according to the recipes indicated above was obtained in comparison with a masterbatch using the organic red pigment PV Echtrosa. In comparison with the masterbatch without the phosphite antioxidant, the masterbatch with phosphite oxidant exhibited a further improvement in the level of pits, i.e. a lower number of pits. No die lines occurred.

We claim:

1. Masterbatch (polymer/pigment concentrate) for the production of support materials for imaging processes comprising
25 to 80% by weight of a titanium dioxide,
20 to 75% by weight of a polyolefin resin,
0.1 to 10% by weight of alkali aluminosulphosilicate red pigment,
0.1 to 6% by weight of a stabilizer
based on the mass of the masterbatch in each case.

2. Masterbatch according to claim 1 wherein the mass ratio of alkali aluminosulphosilicate red pigment to the total mass of the stabilizers is 200:1 to 1:60.

3. Masterbatch according to claim 1 wherein the red pigment is ultramarine violet (CAS 12769-9) and is contained in a quantity of 0.1 to 10% by weight, based on the mass of the masterbatch.

4. Masterbatch according to claim 1 wherein the mass ratio of alkali aluminosulphosilicate red pigment to the total mass of the stabilizers is 200:1 to 1:60 and wherein the red pigment is ultramarine violet (CAS 12769-9) and is contained in a quantity of 0.1 to 10% by weight, based on the mass of the masterbatch.

5. Masterbatch according to claim 1 wherein a phosphite antioxidant is contained as stabilizer in a quantity of 0.05 to 3% by weight, based on the mass of the masterbatch.

6. Masterbatch according to claim 5 wherein the phosphite antioxidant is 2,4,6-tri-tert.-butylphenyl-2-butyl-2-ethyl-1,3-propane diol phosphite.

7. Masterbatch according to claim 1 wherein a phenolic antioxidant is contained as stabilizer in a quantity of 0.05 to 3% by weight, based on the mass of the masterbatch.

8. Masterbatch according to claim 7 wherein the phenolic antioxidant is octadecyl-3,5-di-tert.-butyl-4-hydroxycinnamate.

9. Masterbatch according to claim 1 wherein an ultramarine blue is contained in a quantity of 0.05 to 5% by weight based on the quantity of the masterbatch.

10. Masterbatch according to one of claim 1 wherein a brightener based on a diaminostilbene sulphonic acid derivative, diaryl pyrazolyl derivative and/or bisbenzoxazolyl stilbene derivative is contained as optical brightener in a quantity of 0.05 to 1% by weight.

11. Masterbatch according to claim 1 wherein the polyolefin is a polyethylene with a low or high density or a mixture of both.

12. Masterbatch according to claim 1 wherein the composition of the masterbatch includes
25 to 60% by weight of titanium dioxide,
1.00 to 2.00% by weight of ultramarine violet (CAS 12769-96-9),
0.05 to 5% by weight of ultramarine blue,
0.1 to 0.4% by weight of 2,4,6-tri-tert.-butyl phenyl-2-butyl-2-ethyl-1,3-propane diol phosphite,
0.1 to 0.6% by weight of octadecyl-3,5-di-tert.-butyl-4-hydroxycinnamate,
0.05 to 1% by weight of optical brightener,
40 to 75% by weight of polyethylene (LDPE)
based on the mass of the masterbatch in each case.

13. Support material for imaging processes which comprises a raw paper or a pigment coated raw paper and a polyolefin layer formed on the raw paper or on the pigment layer present on the raw paper, the polyolefin layer is prepared from a masterbatch comprising
25 to 80% by weight of titanium dioxide,
20 to 75% by weight of polyolefin resin,
0.1 to 10% by weight of alkali aluminosulphosilicate red pigment,
0.1 to 6% by weight of stabilizer
based on the mass of the masterbatch in each case.

14. Support material according to claim 13 wherein the polyolefin layer contains 1 to 40% by weight of the masterbatch according to claim 13 and 60 to 99% by weight of a polyolefin selected from HDPE, LDPE, LLDPE, polypropylene and their mixtures.

15. Support material according to claim 13 wherein the mass ratio of alkali aluminosulphosilicate red pigment to the total mass of the stabilizers is 200:1 to 1:60.

14. Support material according to claim 13 wherein the red pigment is ultramarine violet (CAS 12769-9) and is contained in a quantity of 0.1 to 10% by weight, based on the mass of the masterbatch.

15. Support material according to claim 13 wherein the mass ratio of alkali aluminosulphosilicate red pigment to the total mass of the stabilizers is 200:1 to 1:60 and wherein the red pigment is ultramarine violet (CAS 12769-9) and is contained in a quantity of 0.1 to 10% by weight, based on the mass of the masterbatch.

16. Support material according to claim 13 wherein a phosphite antioxidant is contained as stabilizer in a quantity of 0.05 to 3% by weight, based on the mass of the masterbatch.

17. Support material according to claim 16 wherein the phosphite antioxidant is 2,4,6-tri-tert.butylphenyl-2-butyl-2-ethyl-1,3-propane diol phosphite.

18. Support material according to claim 13 wherein a phenolic antioxidant is contained as stabilizer in a quantity of 0.05 to 3% by weight, based on the mass of the masterbatch.

19. Support material according to claim 18 wherein the phenolic antioxidant is octadecyl-3,5-di-tert.-butyl-4-hydroxycinnamate.

20. Support material according to claim 13 wherein an ultramarine blue is contained in a quantity of 0.05 to 5% by weight based on the quantity of the masterbatch.

21. Masterbatch according to claim 13 wherein a brightener based on a diaminostilbene sulphonic acid derivative, diaryl pyrazolyl derivative and/or bisbenzoxazolyl stilbene derivative is contained as optical brightener in a quantity of 0.05 to 1% by weight.

22. Support material according to claim 14 wherein the application weight of the polyolefin amounts to 10 to 40 g/m².
